(19) United States
(12) Patent Application Publication
(10) Pub. No.: US 2022/0205113 A1
(43) Pub. Date: Jun. 30, 2022

(54) ELECTROCATALYTIC HYDROGEN RECOVERY FROM HYDROGEN SULFIDE AND APPLICATION OF THE CIRCULAR HYDROGEN ECONOMY FOR HYDROTREATMENT

(71) Applicant: UOP LLC, Des Plaines, IL (US)

(72) Inventors: Francis Stephen Lupton, Evanston, IL (US); Joshua Hirner, Los Angeles, CA (US)

(21) Appl. No.: 17/522,487

(22) Filed: Nov. 9, 2021

Related U.S. Application Data
(60) Provisional application No. 63/132,676, filed on Dec. 31, 2020.

(51) Int. Cl. C25B 1/02; C25B 11/081

(52) U.S. Cl. CPC C25B 1/02; C25B 11/081

(57) ABSTRACT

An electrochemical process is provided for producing hydrogen for use in a hydrotreatment process. Hydrogen sulfide and ammonia that are produced during the hydrotreatment process are subjected to electrolysis using electrolysis cells and select catalysts to produce hydrogen which then can be used in the hydrotreatment process instead of using outside sources of hydrogen.

This application claims priority to provisional application 63/132,676, filed Dec. 31, 2020 which is incorporated herein in its entirety.

Hydrotreatment is a process for removal of heteroatoms, such as nitrogen and sulfur, from hydrocarbon feeds during the refining process. It relies on catalytic reduction of sulfur and nitrogen species to produce reaction products including ammonia and hydrogen sulfide. These compounds then need to be collected and processed to mitigate their environmental impact. Typically, this involves chemical processes such as the Claus treatment of sulfides and the biological treatment of ammonia. The hydrogen used for the hydrotreatment process is typically produced by steam reforming of methane which is associated with a high greenhouse gas emission in terms of CO₂ produced. Processes such as caustic scrubbing or Claus processing result in the hydrogen being lost from the system as water instead of the more valuable hydrogen for use in hydroprocessing or hydrotreating processes.

An alternative approach to minimizing the need to produce fresh hydrogen for the hydrotreatment process and thus minimizing associated greenhouse gas emissions is to adopt a circular hydrogen economy for this process based upon electrolysis of hydrogen sulfide and ammonia produced during the hydrotreatment process and recovering the hydrogen associated with these compounds for re-use in this process. This electrochemical process can be driven by the use of renewable electrical power with minimal associated greenhouse gas emissions. The increase in the number of hydrogenation processes in refineries coupled with the need to process the heavier oils, which require substantial quantities of hydrogen for upgrading, has resulted in vastly increased demands for hydrogen. Thus, technologies focused on hydrogen production in a safe, efficient, economical and environmentally-friendly manner are becoming highly desirable. In this regard, electrochemical splitting of H₂₅ to produce hydrogen and elemental sulfur is a subject of high technological significance. The electrochemical production of hydrogen from hydrogen sulfide is energetically much more efficient than alternative methods for hydrogen production such as electrolysis of water or steam methane reforming of natural gas and also has a lower greenhouse gas emission.

### SUMMARY OF THE INVENTION

A process is provided for producing hydrogen comprising sending a gas stream comprising hydrogen sulfide to an anode side of an electrochemical cell to oxidize the hydrogen sulfide to produce elemental sulfur and protons and sending the protons through a proton exchange membrane adjacent to the anode side to a cathode side of the electrochemical cell to produce gaseous hydrogen from the protons. In this process, the proton exchange membrane is stable at temperatures above about 115° C. The anode side comprises an anode catalyst comprising a noble or a non-noble metal, metal oxides or metal sulfides. The anode catalyst may be selected from CoS₂—RuO₂, MoS₂, NiS—MoS₂, and FeNC. The anode catalyst may be mixed with a conductive carbon containing material. This conductive carbon containing material may be applied by a spray method, brush painting, drop casting or other applicable method. The cathode side may comprise a cathode catalyst consisting of noble or non-noble metals, metal oxides, metal sulfides or non-metallic materials selected from carbon nanotubes, graphite and diamond. The cathode catalyst may contain at least one of silver, silver sulfide and platinum. In addition, the cathode catalyst may be mixed with a carbon containing material. The mixture of cathode catalyst and carbon containing material may be applied by a spray method, brush painting or drop casting. In the process, the gaseous hydrogen may be sent to a hydrogenation reactor. Other sulfur containing streams to a liquid phase electrochemical cell to separate sulfur from Na₂S or NaHS.

In another embodiment is provided, a system for producing hydrogen comprising a tube capable of transporting a gas or liquid wherein the tube is connected to an electrochemical cell where said electrochemical cell comprises an anode and a cathode with a proton exchange membrane between said anode and said cathode and wherein said anode comprises a catalyst capable of catalyzing hydrogen sulfide into elemental sulfur and protons, where said proton exchange membrane that is stable at temperatures in excess of about 115C and is capable of allowing protons to pass from said anode to said cathode and said cathode comprises a catalyst capable of producing gaseous hydrogen from said protons. The anode catalyst may comprise a noble metal, a non-noble metal, metal oxides or metal sulfides. In particular, the anode catalyst may be selected from CoS₂—RuO₂, MoS₂, NiS—MoS₂, and FeNC. The cathode catalyst may be selected from noble metals, non-noble metals, metal oxides and metal sulfides. More specifically, the cathode catalyst may be selected from silver, silver sulfide and platinum. The proton exchange membrane is capable of proton exchange at temperatures between about 115° C. and 200° C. The anode catalyst or the cathode catalyst or both are mixed with a conductive carbon to produce a catalyst-carbon mixture and then the catalyst-carbon mixture is applied to a conductive catalyst backing material.

### BRIEF DESCRIPTION OF THE DRAWINGS

FIG. 1 shows a simplified flow scheme of a hydrogenation process of the present invention.

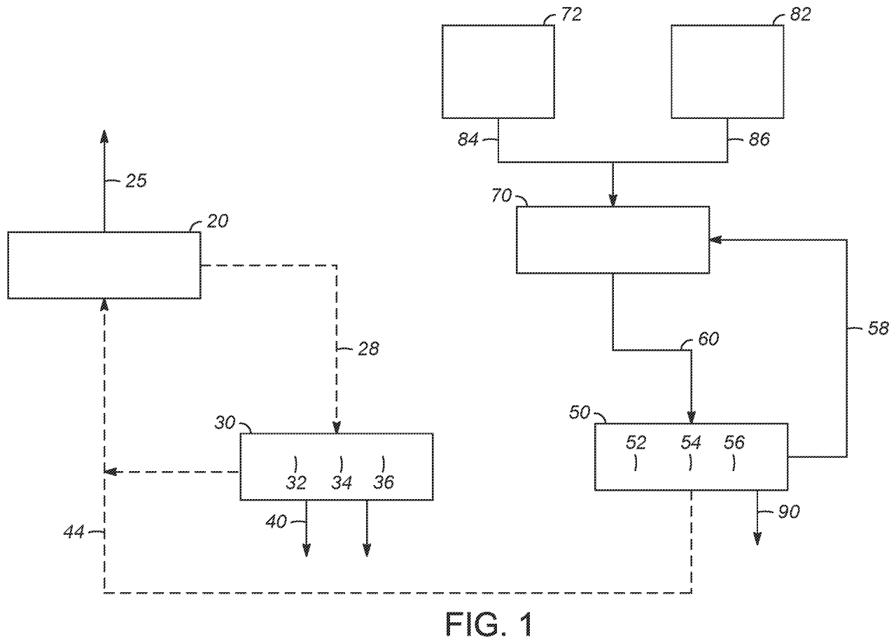

FIG. 2 shows the production of hydrogen with the increase in current density increasing with the introduction of the humidification.

FIG. 3 shows the current over time of a cell.

FIG. 4 shows that a comparison of the platinum catalyst to the silver catalyst.

FIG. 5 shows differences in current density between methods of applying anode cathodes.

### DETAILED DESCRIPTION

The increase in the number of hydrogenation processes in refineries coupled with the need to process the heavier oils, which require substantial quantities of hydrogen for upgrading, has resulted in vastly increased demands for hydrogen. Thus, technologies focused on hydrogen production in a safe, efficient, economical and environmentally-friendly manner are becoming highly desirable. In this regard, electrochemical splitting of H₂S to produce hydrogen and elemental sulfur is a subject of high technological significance. The electrochemical production of hydrogen from hydrogen sulfide is energetically much more efficient than alternative methods for hydrogen production such as electrolysis of water or steam methane reforming of natural gas and also has a lower greenhouse gas emission.

TABLE 1

| | | Maximum | Min. Energy | | CO₂ |
|---|---|---|---|---|---|
| | | moles of H2 | Required | | emissions |
| | Overall | produced | (MWh/MT | Cost of H₂ | (MT CO₂/MT |
| Process | Reactions | with 1 kWh | H₂ | ($/MT H₂) | H₂) |
| Water Splitting | Water to O₂ and H₂ | 15 | 33 | 3956 | 10.5 |
| H₂S hydrolysis | H₂S to H₂ and S | 131 | 4 | 480 | 1.3 |
| Steam Reforming | CH₄ + H₂O to CO and H₂ | | | 1355 | 12 |

In the above table, it can be seen that the cost of producing hydrogen by hydrolysis of hydrogen sulfide is much less than either the hydrolysis of water or a steam reforming process with much lower production of carbon dioxide.

Hydrogen is used to remove sulfur contaminants during the refining of petroleum. This hydrogen reacts with sulfur compounds to create hydrogen sulfide which is a toxic hazardous gas that must be treated to prevent exposure and release to the environment. Processes such as caustic scrubbing or Claus processing result in the hydrogen being lost from the system as water.

Electrolysis on the other hand enables the recovery of hydrogen from the hydrogen sulfide waste, leaving elemental sulfur which is a feedstock for other chemical processes such as sulfuric acid and fertilizer. This recovered hydrogen can be recycled back to the hydrotreatment process, reducing the need for new hydrogen produced from steam methane reforming or other sources. In addition, electrolysis may be used for recovery of hydrogen where feasible elsewhere in the process.

The process that is provided herein is a process to efficiently convert hydrogen sulfide to hydrogen gas and elemental hydrogen: H₂S →H₂+S⁰. The key parameters for any electrochemical process are the Faradaic efficiency which is a measure of the percentage of electrons that are being utilized by the electrochemical reactions of interest rather than being lost to non-chemical reactions such as resistive heating. Faradaic efficiency is a measure of selectivity that treats electrons as a chemical reagent. The second parameter is overpotential which is a kinetic parameter related to activation energy and is the actual potential that is needed above the theoretical electrical potential)(E⁰) to make the chemical reaction proceed. The other parameter is current density which is a measure of the flow of electrons across the electrochemical cell and dictates size of electrode & cell required to meet a fixed production rate.

The electrochemical conversion of hydrogen sulfide represents a number of challenges. The oxidation of hydrogen sulfide to elemental sulfur must be performed at a temperature above the melting point of sulfur (>115° C.) so that molten sulfur can flow out of the electrochemical cell and will not result in the plugging of the anode compartment of the cell. Thus, the cell components, such as in a proton exchange membrane (PEM) separating the anode and cathode compartments must be able to tolerate temperatures above 115° C. Nafion™ (the brand name for a sulfonated tetrafluorethylene based fluoropolymer-copolymer that is a brand of the Chemours Company) is a proton conducting membrane known to be used in PEM electrolysis cells. However, but Nafion polymer has poor stability at elevated temperatures. One membrane that can be used in an electrochemical cell and can tolerate temperatures in the range at which elemental sulfur is molten is a phosphoric acid doped polybenzimidazole (PBI) membrane. This membrane is particularly suitable for use in electrochemical cells for converting hydrogen sulfide to gaseous hydrogen and molten elemental sulfur.

A key factor that affects any electrochemical process and is the choice of electrode catalysts at both the cell anode and the cell cathode. Oxidative reactions (that generate protons & electrons) occur at the anode and reductive reactions (that consume protons and electrons) occur at the cathode. A number of potential catalysts can be used at the anode. These include noble metals such as platinum, gold, iridium, silver, and ruthenium in metallic form or as oxides or as sulfides. Non-noble metals can also be used as anodic catalysts in metallic form or as oxides or sulfides. These non-noble metals include nickel, molybdenum, copper, iron, bismuth, cadmium, and cobalt. Furthermore, mixtures of noble and non-noble metals can be used as anode catalysts as pure metals or as oxides or as sulfides. Anode catalysts can also be made from non-metallic substances such as various forms of carbon such as carbon nanotubes, graphite or diamond.

Another aspect of the process is provided a circular hydrogen economy for hydrotreating as shown in the Figure in one possible configuration. A hydrocarbon feed 11 that contains sulfur containing materials is shown entering a hydrotreating reactor 20 in which a desulfided hydrocarbon product stream 25 is shown exiting. A stream 28 is sent from hydrotreating reactor 20 to electrochemical cell 30 for gas phase electrolysis. Within electrochemical cell 30 are shown an anode 32, membrane 34 and cathode 36 which produces a sulfur stream 40 and a hydrogen stream 42 which can be recycled in stream 44 to hydrotreating reactor 20. In this example of a circular hydrogen economy is shown that liquid phase electrolysis can be employed in the process to remove sulfur from other processes that produce sulfur containing compounds such as a process 72 to dehydrogenate light paraffins to produce light olefins or a process 82 to oxidize mercaptans with streams 84 and 86 passing to an hydrogen sulfide scrubber 70 in which a sodium hydroxide stream 58 is used to produce sodium sulfide compounds including Na₂S and NaHS. in stream 60 that are sent to an electrochemical cell 50 for liquid phase electrolysis in which there are anode 52, membrane 54 and cathode 56. A hydrogen stream 44 is shown exiting electrochemical cell 50 with hydrogen separated from NaHS and then being sent to hydrotreating reactor 20. A stream 90 of sulfur is shown exiting the electrochemical cell 50.

The following example shows the performance of various anode catalysts on the current density of an electrochemical cell converting hydrogen sulfide to elemental sulfur and hydrogen.

### EXAMPLE 1

Process conditions: Cell potential: −2 V. Cell T: 120° C., feed: humidified H₂S (50 sccm, anode) and humidified N₂ (50 sccm , cathode), membrane: H₃PO₄-doped PBI, MEA: Hot pressed @ 130° C. for 90 s using 0.75 tonnes, electrocatalyst loading: 8 mg/cm² for anode catalyst and 1 mg Pt/cm2 for cathode (Pt/C)

| | Current Density |
|---|---|
| Anode Catalyst | (mA/cm2) |
| CoS₂—RuO₂ | −20 |
| MoS₂ | −42 |
| NiS—MoS₂ | −117 |
| FeNC | −197 |

The electrochemical reaction requires proton exchange between the anode and cathode compartments by means of the proton exchange membrane, such as the acid doped PBI membrane. To promote this exchange the membrane needs to be hydrated. A convenient way to keep the PEM hydrated is to humidify the feed gas to the electrochemical cell. The following example shows the impact of humidifying versus not humidifying the feed gas to the electrochemical cell.

### EXAMPLE 2

Process conditions: Cell potential: −2 V. Cell T: 120° C., feed: H₂S (50 sccm, anode) and N₂ (50 sccm , cathode), humidifier temperature: 60° C., membrane: H₃PO₄-doped PBI,

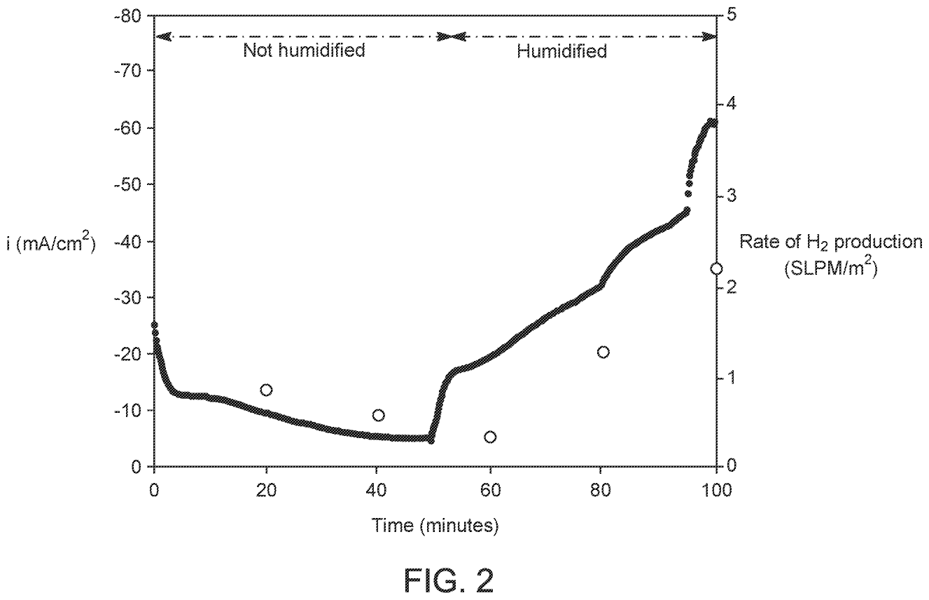

MEA: Hot pressed @ 77° C. for 90 s using 0.75 tonnes, electrocatalyst loading: 8 mg/cm² for anode (NiS-MoS₂) and cathode (Ag). For a period of 50 minutes, the gas flow to the cell was not humidified. After 50 minutes the gas to the cell was humidified by bubbling the gas through a column of water to saturate the gas with water vapor prior to the gas entering the cell. The current density during the non-humidified phase dropped from −25 to −5 mA/cm². During the humidification phase the current density increased from −5 to −60 mA/cm². Similarly, the rate of hydrogen formation dropped to a level of 0.2 Standard Liters Per Minute (SLPM)/m² during the non-humidified phase but rose to 2.2 SLPM/m² during the humidified phase. FIG. 2 shows the production of hydrogen with the increase in current density increasing with the introduction of the humidification.

### EXAMPLE 3

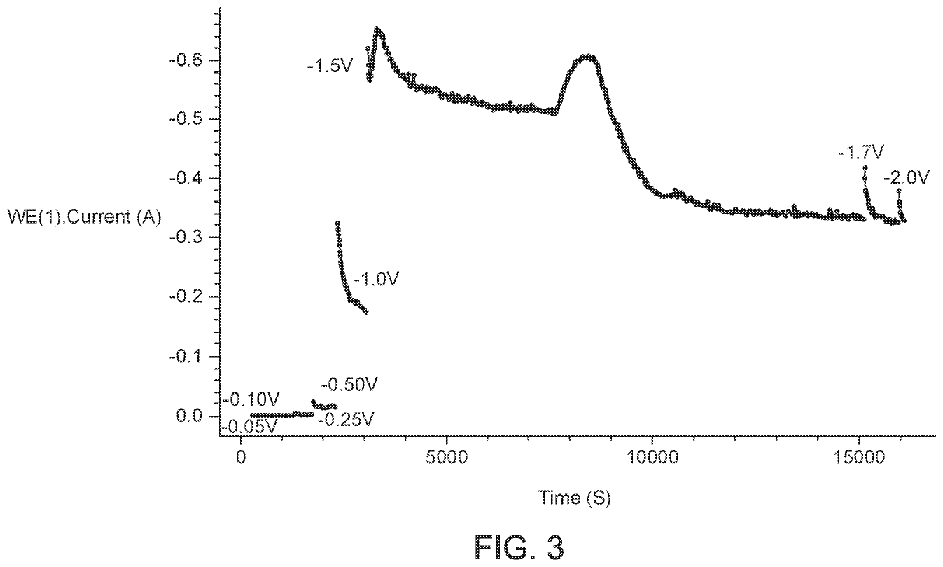

Process conditions: Cell T: 120° C., feed: humidified H25 (50 sccm, anode) and humidified N2 (50 sccm , cathode), membrane: H3PO4-doped PBI and stabilized for 42 h at 105° C. in air, MEA: Hot pressed @ 130° C. for 90 s using 0.75 tonnes, electrocatalyst loading: 4 mg/cm^{2 f}or anode NiS-MoS₂/VC 1 mg Pt/cm² for cathode (Pt/C). A step-wise increase in electrical potential was applied to the cell. There was a noticeable jump in the current density when a voltage of −1.0 volt was applied to the cell and a further increase at −1.5 volts. However, beyond −1.5 V no further increase in current was observed. The Faradaic efficiency for H₂ formation from H₂S was determined to be 100% at the applied voltage of −1.5 V. FIG. 3 shows the current over time.

The anode catalyst oxidizes hydrogen sulfide to elemental sulfur while generating protons & electrons. The protons that are generated at the anode exchange through the proton exchange membrane to the cathode where they are catalytically recombined to form hydrogen gas. The ability of the cathode catalyst to efficiency produce hydrogen at the cathode will affect the overall efficiency of the cell to convert hydrogen sulfide to hydrogen and sulfur. A comparison of silver and platinum cathode catalysts is shown in the following example.

### EXAMPLE 4

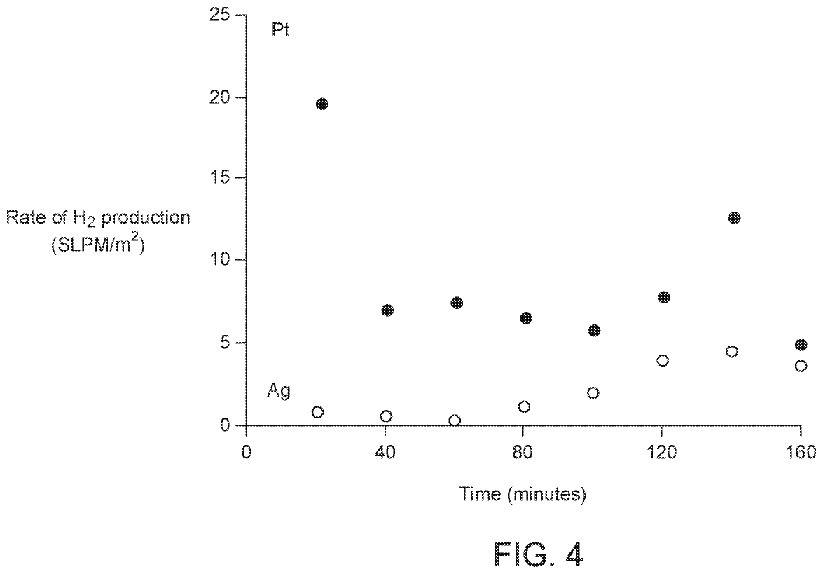

Process conditions: Cell potential: −2 V. Cell T: 120° C., feed: humidified H₂S (50 sccm, anode) and N₂ (50 sccm , cathode), humidifier temperature: 60° C. membrane: H₃PO₄-doped PBI, MEA: Hot pressed @ 77° C. for 90 s using 0.75 tonnes, electrocatalyst loading: 8 mg/cm² for anode (NiS-MoS₂) and cathode (Ag or Pt). The platinum catalyst showed significantly greater average rate of hydrogen production (8 SLPM/m²) than the silver catalyst (3 SLPM/m²) as shown in FIG. 4.

Various methods of preparing both anode and cathode catalysts are known. Typically, the metal containing catalyst is mixed with an ion conducting polymer, usually the same polymer that is used for the ion-conducting membrane. This solution is then applied to the surface of an electrical conducing support such as carbon paper or carbon felt that provides electrical connection to the cell conductive surface. It was found that the addition of Vulcan Carbon along with the conducting polymer significantly improved electrical conductivity between the active anode metal containing catalysts as shown in the following example.

### EXAMPLE 5

Process conditions: Cell potential: −2 V. Cell T: 120° C., feed: humidified H₂S (50 sccm, anode) and N₂ (50 sccm , cathode), membrane: H₃PO₄-doped PBI and stabilized overnight at 105° C., MEA: Hot pressed @ 130° C. for 90 s using 0.75 tonnes, electrocatalyst loading: 8 mg/cm² for anode (NiS-MoS₂ or NiS-MoS₂ with Vulcan carbon) and 1 mg Pt/cm² for cathode (Pt)

| | Current Density | Rate of hydrogen |
|---|---|---|
| Catalyst | mA/cm² | Production SLPM/m2 |
| NiS—MoS₂ | 117 | 5 |
| NiS—MoS₂ with | 250 | 15 |
| Vulcan carbon | | |

As well as the composition of the catalyst compound, how it is applied to the conductive carbon paper or felt backing was found to have a significant effect on the performance of the electrochemical cell. Three ways in which the catalyst is applied to the conductive backing include: Spray application in which the catalyst solution is sprayed onto the backing using a spray-gun to paint the backing with the catalyst material in a similar manner in which paint is spray applied to a surface. Brush painting in which a brush is used to paint the conductive backing with the catalyst compound in a similar manner in which paint is applied to a surface with a brush. Drop casting, in which the catalyst is applied by addition of drops of catalyst compound applied to the surface and let to spread by natural capillary action.

The effectiveness of different application methods and cell performance is shown in the following example.

### EXAMPLE 6

Process conditions: Cell potential: −2 V. Cell T: 120° C., feed: humidified H₂S (50 sccm, anode) and N₂ (50 sccm , cathode), membrane: H₃PO₄-doped PBI and stabilized overnight at 105° C., MEA: Hot pressed @ 130° C. for 90 s using 0.75 tonnes, electrocatalyst loading: 8 mg/cm² for anode (NiS-MoS₂with Vulcan carbon applied to backing by three methods) and 1 mg Pt/cm² for cathode (Pt).

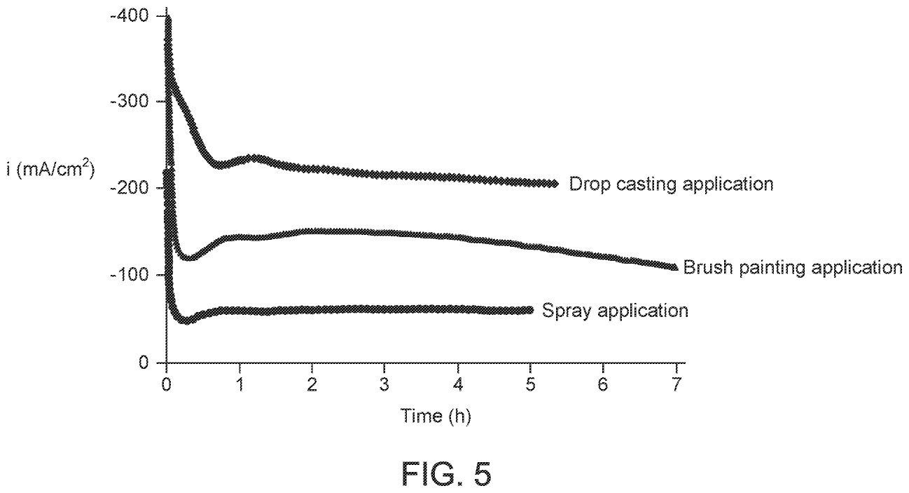

The drop casting of the anode catalyst onto the conductive backing gave the best current density in the cell, 225 mA/cm² whereas brush painting showed current density of about 125 mA/cm² and spray application gave the lowest current density of about 50 mA/cm². FIG. 5 shows the differences in current density with drop casting more effective than brush painting which is more effective than the spray application

1. A process for producing hydrogen comprising
a. sending a gas stream comprising hydrogen sulfide to an anode side of an electrochemical cell to oxidize said hydrogen sulfide to produce elemental sulfur and protons,
b. sending said protons through a proton exchange membrane adjacent to said anode side to a cathode side of said electrochemical cell to produce gaseous hydrogen from said protons.

2. The process of claim 1 wherein said proton exchange membrane is stable at temperatures above about 115° C.

3. The process of claim 1 wherein said anode side comprises an anode catalyst comprising a noble or a non-noble metal, metal oxides or metal sulfides.

4. The process of claim 3 wherein said anode catalyst is selected from CoS₂-RuO₂, MoS₂, NiS-MoS₂, and FeNC.

5. The process of claim 3 wherein said anode catalyst is mixed with a conductive carbon containing material.

6. The process of claim 5 wherein said mixture of said anode catalyst and said conductive carbon containing material is applied by a spray method, brush painting or drop casting.

7. The process of claim 1 wherein said cathode side comprises a cathode catalyst consisting of noble or non-noble metals, metal oxides, metal sulfides or non-metallic materials selected from carbon nanotubes, graphite and diamond.

8. The process of claim 5 wherein the cathode catalyst is selected from silver, silver sulfide and platinum.

9. The process of claim 6 wherein said cathode catalyst is mixed with a carbon containing material.

10. The process of claim 9 wherein said mixture of cathode catalyst and carbon containing material is applied by a spray method, brush painting or drop casting.

11. The process of claim 1 wherein said gaseous hydrogen is sent to a hydrogenation reactor.

12. The process of claim 1 further comprising sending other sulfur containing streams to a liquid phase electrochemical cell to separate sulfur from Na₂S or NaHS.

13. A system for producing hydrogen comprising a tube capable of transporting a gas or liquid wherein said tube is connected to an electrochemical cell where said electrochemical cell comprises an anode and a cathode with a proton exchange membrane between said anode and said cathode and wherein said anode comprises a catalyst capable of catalyzing hydrogen sulfide into elemental sulfur and protons, where said proton exchange membrane that is stable at temperatures in excess of about 115C and is capable of allowing protons to pass from said anode to said cathode and said cathode comprises a catalyst capable of producing gaseous hydrogen from said protons.

14. The system of claim wherein said anode catalyst comprises a noble metal, a non-noble metal, metal oxides or metal sulfides.

15. The system of claim 6 wherein said anode catalyst is selected from CoS₂-RuO₂, MoS₂, NiS-MoS₂, and FeNC.

16. The system of claim 5 wherein the cathode catalyst is selected from noble metals, non-noble metals, metal oxides and metal sulfides.

17. The system of claim 8 wherein the cathode catalyst is selected from silver, silver sulfide and platinum.

18. The system of claim 5 wherein said proton exchange membrane is capable of proton exchange at temperatures between about 115° C. and 200° C.

19. The system of claim 5 wherein the anode catalyst or the cathode catalyst or both are mixed with a conductive carbon to produce a catalyst-carbon mixture and then the catalyst-carbon mixture is applied to a conductive catalyst backing material.
